(19) United States
(12) Patent Application Publication
(10) Pub. No.: US 2005/0264551 A1
(43) Pub. Date: Dec. 1, 2005

(54) Multi-driving circuit and active-matrix display device using the same

(75) Inventors: Tsau Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/141,936

(22) Filed: May 31, 2005

(30) Foreign Application Priority Data
May 28, 2004 (TW) 93115292

(51) Int. Cl. G09G 5/00

(52) U.S. Cl. 345/204

(57) ABSTRACT

An active-matrix display device (2) includes a substrate (250), a plurality of scanning lines (120) and data lines (140) formed on the substrate, a gate driving IC device (200) with a plurality of outputs for supplying scanning signals to the scanning lines, a source driving IC (400) for supplying data signals to the data lines, a multi-driving circuit (240) connecting with the gate driving IC device. The quantity of outputs of the gate driving IC can be expanded by the multi-driving circuit. This reduces the quantity of gate driving ICs needed, and thus lowers the cost of the active-matrix display device.

### FIELD OF THE INVENTION

The present invention relates to an active-matrix display device, and particularly to an active-matrix display device employing a multi-driving circuit which can expand the quantity of outputs so as to reduce the quantity of gate driving ICs (integrated circuits).

### BACKGROUND

Recently, flat displays such as Plasma Display Panels (PDPs), Liquid Crystal Displays (LCDs), Organic Electroluminescence Displays (OLEDs), Field Emission Displays (FEDs) and Liquid Crystal on Silicon (LCOS) have been developed to be used in a wide range of applications, from small sized cell phones to large sized televisions. In order to fulfill the demand for large displays with high resolution, the active matrix driving mode is commonly used. The active matrix driving mode is driven by an external driving IC or System On Glass (SOG) technology.

As shown in FIG. 3, a typical active-matrix display 1 includes a substrate 25, a gate driving IC 20, and a source driving IC 40. A plurality of scanning lines 12 and data lines 14 are arranged on the substrate 25 in the form of a crisscross matrix type of pattern. A plurality of pixel units 10 are defined between intersections of the scanning lines 12 and data lines 14. The gate driving IC 20 and the source driving IC 40 connect to the scanning lines 12 and data lines 14, for transmitting of driving signals.

FIG. 4 shows various waveforms of the gate driving IC 20 and the scanning lines 12. In a period of time T1-Tn, the gate driving IC 20 sequentially scans the scanning lines 12 row by row. S1, S2 . . . Sn represent the waveforms of each output of the gate driving IC 20, and G1, G2 . . . Gn represent the waveforms of each scanning line 12 according to the outputs. Each output connects to a respective scanning line 12, whereby they have the same waveforms.

However, in the case of a display using Super Extended Graphics Array (SEGA, 1280×3×1024 pixels), 3840 data lines and 1024 scanning lines are needed. The number of driving ICs required is correspondingly high. This may significantly inflate the cost of the active-matrix display.

What is needed, therefore, is an active-matrix display that overcomes the above-described deficiencies.

### SUMMARY

In a preferred embodiment, an active-matrix display device includes a substrate, a plurality of scanning lines and data lines formed on the substrate, a gate driving IC (integrated circuit) device with a plurality of outputs for supplying scanning signals to the scanning lines, a source driving IC for supplying data signals to the data lines, a multi-driving circuit connecting with the gate driving IC device and the scanning lines for expanding the quantity of outputs of the gate driving IC device.

The quantity of outputs of the gate driving IC can be expanded by the multi-driving circuit. This reduces the quantity of gate driving ICs needed, and thus lowers the cost of the active-matrix display device 2.

Other advantages and novel features of the embodiments will become more apparent from the following detailed description when taken in conjunction with the accompanying drawings.

### BRIEF DESCRIPTION OF THE DRAWINGS

FIG. 1 is a schematic view of an active-matrix display device, according to a preferred embodiment of the present invention.

FIG. 2 is a schematic, plan view of the waveforms of a signal through outputs of the gate driving IC and the multi-driving circuit of FIG. 1, according to the preferred method of the present invention.

FIG. 3 is a schematic view of a conventional active-matrix display device.

FIG. 4 is a schematic plan view of the waveforms of a signal through outputs of the gate driving IC and the scanning lines of FIG. 3.

### DETAILED DESCRIPTION OF PREFERRED EMBODIMENT

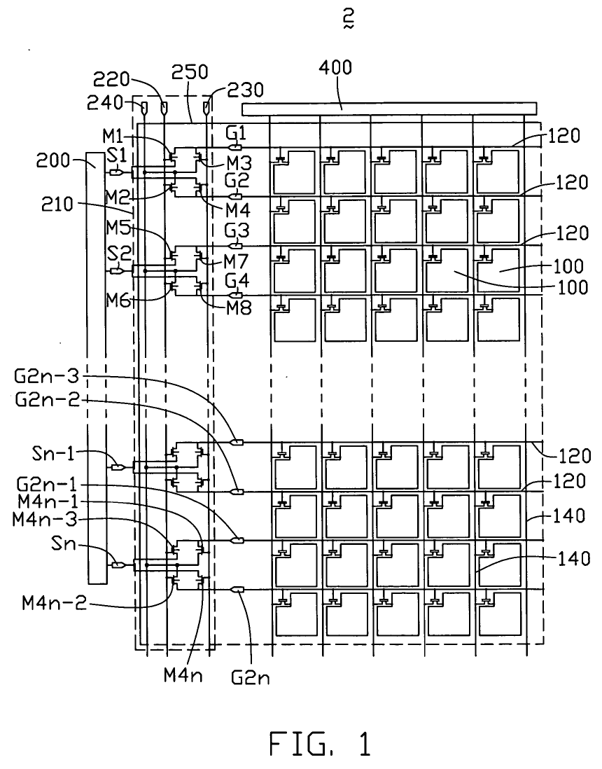

FIG. 1 is a simplified, schematic view of an active-matrix display device 2 according to a preferred embodiment of the present invention. The active-matrix display device 2 includes a substrate 250, a plurality of scanning lines 120 and data lines 140, a plurality of pixel units 100, a gate driving IC device 200, a source driving IC 400, and a multi-driving circuit 210. The scanning lines 120 and data lines 140 are arranged on the substrate 250 perpendicular to each other, so as to form a crisscross matrix type of pattern. The pixel units 100 are arranged between corresponding intersections of the scanning lines 120 and data lines 140. The gate driving IC device 200 has a plurality of outputs S1, S2 . . . Sn−1, Sn (n represents a natural number).

The multi-driving circuit 210 includes two controlling signal lines 220, 230, a low-voltage direct current source 240, and a plurality of thin film transistors represented as M1, M2 . . . M(4n−1), M4n (n represents a natural number). The transistors M1 to M4 and the output S1 are now described in detail, as being exemplary of the structure and operation of the active-matrix display device 2. The gates of the transistors M1 and M2 connect to the controlling signal line 220, and the gates of the transistors M3 and M4 connect to the controlling signal line 230. The sources of the transistors M2 and M3 connect to the low-voltage direct current source 240, and the sources of the transistors M1 and M4 connect to the output S1 of the gate driving IC device 200. The drains of the transistors M1 and M3 are connected as a signal output G1 to transmit driving signals to a scanning line 120, and the drains of the transistors M2 and M4 are connected as a signal output G2 to transmit driving signals to another scanning line 120. Therefore, the signal of the output S1 is outputted by the signal outputs G1 and G2. As a whole, the multi-driving circuit 210 expands the quantity of the outputs of the gate driving IC device 200 from n to 2n (G1, G2 . . . G2n).

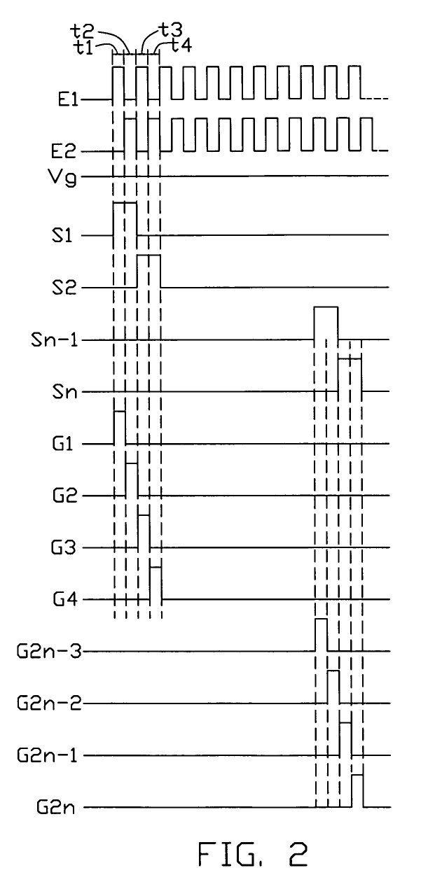

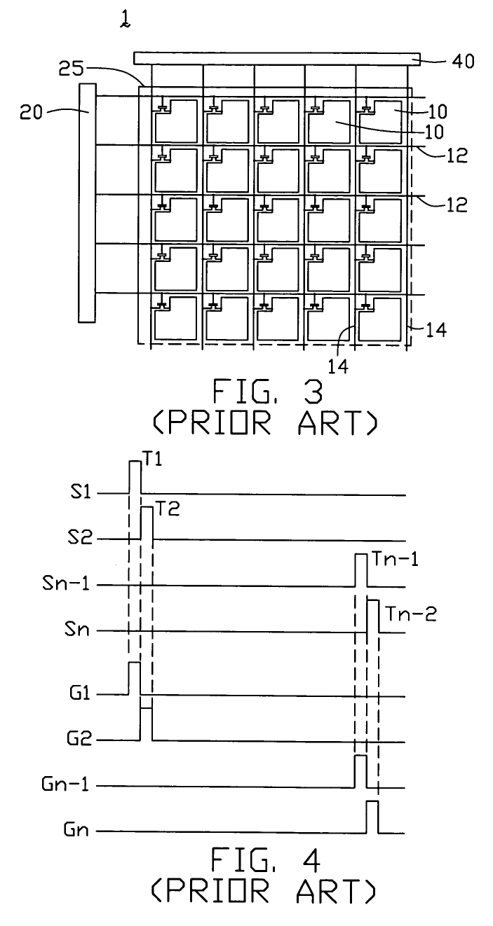

FIG. 2 schematically shows waveforms of various signals passing through outputs of the gate driving IC device 200 and the multi-driving circuit 210. E1 is a pulse signal provided to the controlling signal line 220, for controlling the gates of the transistors M1 and M2. E2 is another pulse signal, which has a phase that is the reverse of E1. E2 is provided to the controlling signal line 230, for controlling the gates of the transistors M3 and M4. Vg represents the signal of the low-voltage direct current source 240. S1, S2 . . . Sn−1, Sn represent the output signals of the gate driving IC device 200 respectively, and G1, G2 . . . G2n−1, G2n represent the output signal of the multi-driving circuit 210.

In the period t1, E1 is at a high voltage E1 in order to turn M1 and M2 on. Simultaneously, E2 is at a low voltage in order to turn M3 and M4 off. Accordingly, S1 has a high voltage and G1 outputs an equal high voltage, and Vg has a low voltage and G2 outputs an equal low voltage. In the period t2, E2 is at a high voltage in order to turn M3 and M4 on. Simultaneously, E1 is at a low voltage in order to turn M1 and M2 off. Accordingly, S1 has a high voltage and G2 outputs an equal high voltage, and Vg has a low voltage and G1 outputs an equal low voltage. In the periods t3 and t4, the gate driving IC device 200 scans another scanning line 120. In the period t3, G3 has a high voltage and G4 has a low voltage. In the period t4, G4 has a high voltage and G3 has a low voltage. By repetition of the above-described scanning process, scanning of the n scanning lines is completed.

The operation processes and activities of M5 through M4n and of S2 through Sn are the same as those described above in relation to M1 through M4 and S1.

In the described embodiment, each output of the gate driving ICs (not labeled) is expanded to two outputs connecting to scanning lines by the multi-driving circuit 210. Further, each output of the gate driving ICs can be expanded to four or more outputs by arranging four or more controlling signal lines 220, 230 in the multi-driving circuit 210. Preferably, the transistors M1-M4n are made of low temperature poly-silicon (LTPS) or amorphous silicon, and the transistors M1-M4n are P-channel transistors.

In the above-described scanning process, the controlling signal lines 220, 230 can turn the transistors M1, M2, M3, and M4 on/off sequentially to avoid interference. The outputs of the gate driving IC device 200 can be expanded. This reduces the quantity of gate driving ICs needed, and thus lowers the cost of the active-matrix display device 2.

It is to be understood, however, that even though numerous characteristics and advantages of the embodiment have been set out in the foregoing description, together with details of the structure and function of the embodiment, the disclosure is illustrative only, and changes may be made in detail, especially in matters of shape, size, and arrangement of parts within the principles of the invention to the full extent indicated by the broad general meaning of the terms in which the appended claims are expressed.

1. An active-matrix display device, comprising:
a substrate;
a plurality of scanning lines and data lines formed on the substrate;
a gate driving IC (integrated circuit) device with a plurality of outputs for supplying scanning signals to the scanning lines;
a source driving IC for supplying data signals to the data lines;
a multi-driving circuit connecting with the gate driving IC device and the scanning lines for expanding the quantity of outputs of the gate driving IC device.

2. The active-matrix display device as claimed in claim 1, wherein the multi-driving circuit comprises a low-voltage direct current source, a plurality of controlling signal lines, and a plurality of thin film transistors, gates of each of first and second transistors connect to a first controlling signal line, gates of each of third and fourth transistors connect to a second controlling signal line, sources of each of second and third transistors connect to the low-voltage direct current source, sources of each of first and fourth transistors connect to the gate driving IC device, drains of each of first and third transistors connect to a first scanning line, and drains of each of second and fourth transistors connect to a second scanning line.

3. The active-matrix display device as claimed in claim 2, further comprising a plurality of pixel units defined by intersections of the scanning lines and data lines, and a plurality of switch elements arranged at the intersections of the scanning lines and data lines, the switch elements connecting to the pixel units.

4. The active-matrix display device as claimed in claim 3, wherein the switch elements are transistors.

5. The active-matrix display device as claimed in claim 4, wherein the transistors are made of low temperature poly-silicon.

6. The active-matrix display device as claimed in claim 4, wherein the transistors are made of amorphous silicon.

7. The active-matrix display device as claimed in claim 4, wherein the transistors are P-channel transistors.

8. A multi-driving circuit, comprising:
a low-voltage direct current source;
a plurality of controlling signal lines; and
a plurality of thin film transistors;
wherein gates of each two transistors connect to a same controlling signal line, one of the sources of each two transistors connects to the low-voltage direct current source, the other source of each two transistors is an input of the multi-driving circuit, and the drain of each transistor is an output of the multi-driving circuit.

9. A method of making multi-driving circuit, comprising:
providing a low-voltage direct current source;
providing a plurality of controlling signal lines; and
providing a plurality of thin film transistors;
wherein gates of each two transistors connect to a same controlling signal line, one of the sources of each two transistors connects to the low-voltage direct current source, the other source of each two transistors is an input of the multi-driving circuit, and the drain of each transistor is an output of the multi-driving circuit.
